(19) United States
(12) Patent Application Publication
(10) Pub. No.: US 2013/0063617 A1
(43) Pub. Date: Mar. 14, 2013

(54) LENS BARREL AND IMAGING APPARATUS

(71) Applicants: Masae MIYAKAWA, Yokohama-shi (JP); Katsutoshi SASAKI, Yokohama-shi (JP)

(72) Inventors: Masae MIYAKAWA, Yokohama-shi (JP); Katsutoshi SASAKI, Yokohama-shi (JP)

(73) Assignee: SAMSUNG ELECTRONICS CO. LTD., Suwon-si (KR)

(21) Appl. No.: 13/608,351

(22) Filed: Sep. 10, 2012

(30) Foreign Application Priority Data
Sep. 12, 2011 (JP) 1986222011
Sep. 4, 2012 (KR) 1020120097434

(51) Int. Cl. G02B 27/64; H04N 5/228

(52) U.S. Cl. 348/208.99; 359/557; 348/E05.031

(57) ABSTRACT

A lens barrel configured such that an optical image stabilization lens in the lens barrel is retreated from the optical axis of the lens barrel to be accommodated in a desired position through a series of operations is provided. The lens barrel includes a lens group configured to be moved in the direction of the optical axis in response to a zooming or focusing operation, an Optical Image Stabilization (OIS) lens movable in a direction perpendicular to the optical axis, and an OIS lens assembly which is equipped with the OIS lens, the OIS lens assembly being arranged to retreat the OIS lens from the optical axis and to move the OIS lens in a direction following the optical axis at the time of retraction of the lens group.

### PRIORITY

This application claims the benefit under 35 U.S.C. §119(a) of a Japanese patent application filed on Sep. 12, 2011 in the Japanese Patent Office and assigned Serial No. 198622/2011, and a Korean patent application filed on Sep. 4, 2012 in the Korean Patent Office and assigned Serial No. 10-2012-0097434, the entire disclosures of each of which are hereby incorporated by reference.

### BACKGROUND OF THE INVENTION

1. Field of the Invention

The present invention relates to a lens barrel and an imaging apparatus. More particularly, the present invention relates to retreating a lens barrel in an imaging apparatus.

2. Description of the Related Art

According to the related art, a mechanism for retreating a lens in a lens barrel used in a digital camera or the like has been known which retreats the lens by rotating some of the lenses in the lens barrel up, down, left and right, or through an upward or downward saltation of the lenses at the time of retraction. An exemplary mechanism is a mechanism for retreating an optical image stabilization optical system. Other mechanisms rotate some of the lenses in an optical system to be retreated from an optical axis, and then move the lenses backward.

However, in the related art, only an operation for retreating some of the lenses in the lens barrel from an optical axis is performed, or an operation for retreating the lenses from the optical axis and an operation for reciprocating the lenses forward and backward are separately performed. Due to this, there arise problems in that it is difficult to retreat some of the lenses in the lens barrel from the optical axis to be accommodated in a desired position through a series of operations, and the retreating operation is troublesome.

The above information is presented as background information only to assist with an understanding of the present disclosure. No determination has been made, and no assertion is made, as to whether any of the above might be applicable as prior art with regard to the present invention.

### SUMMARY OF THE INVENTION

Accordingly, an aspect of the present invention are to address the above-mentioned problems and/or disadvantages and to provide at least the advantages described below, and to provide a novel and improved lens barrel and imaging apparatus in which a optical image stabilization lens within a lens barrel is allowed to be retreated from an optical axis and to be moved in the direction of the optical axis to be accommodated in a desired position through a series of operations.

In accordance with an aspect of the present invention, a lens barrel is provided. The lens barrel includes a lens group arranged to move in the direction of an optical axis at the time of retraction, an optical image stabilization lens arranged to be movable in a direction perpendicular to the optical axis, and a stabilization lens assembly equipped with the optical image stabilization lens, the stabilization lens assembly being arranged to move the optical image stabilization lens in the direction following the optical axis as well as to retreat the optical image stabilization lens from the optical axis at the time of retraction of the lens group.

According to another aspect of the present invention, the lens barrel may further include a base arranged to support the stabilization lens assembly to be capable of being rotated about a shaft parallel to the optical axis, and the stabilization lens assembly may be rotated about the shaft to retreat the optical image stabilization lens from the optical axis.

According to another aspect of the present invention, the base may be provided with a slope, against which the stabilization lens assembly abuts, and the stabilization lens assembly is moved along the slope when the stabilization lens is rotated about the shaft to move the optical image stabilization lens in the direction following the optical axis.

According to another aspect of the present invention, the lens barrel may further include a retaining frame arranged to retain the base to be capable of being moved in the direction perpendicular to the optical axis at the time of releasing the retraction, and a fixing member supported to be rotatable with respect to the retaining frame, and arranged to fix the base with respect to the retaining frame at the time of retraction.

According to another aspect of the present invention, the fixing member may retain the outer periphery of the base by being rotated at the time of retraction, thereby fixing the base with respect to the retaining frame in the direction perpendicular to the optical axis.

According to another aspect of the present invention, the fixing member may retain a face of the base perpendicular to the optical axis by being rotated at the time of retraction, thereby fixing the base with respect to the retaining frame in the direction of the optical axis.

According to another aspect of the present invention, the fixing member may rotate the stabilization lens assembly about the shaft by being rotated at the time of retraction.

In accordance with another aspect of the present invention, an imaging apparatus is provided. The apparatus includes a lens group belonging to an imaging optical system for imaging an optical image of a subject, and arranged to be moved in the direction of an optical axis at the time of retraction, an imaging device having an imaging plane, to which the optical image of the subject is imaged by the imaging optical system, for converting the optical image into an electric signal, a optical image stabilization lens belonging to the imaging optical lens, and arranged to be movable in a direction perpendicular to the optical axis, and a stabilization lens assembly equipped with the optical image stabilization lens, the stabilization lens assembly being arranged to move the optical image stabilization lens in the direction following the optical axis as well as to retreat the optical image stabilization lens from the optical axis at the time of retraction of the lens group.

In accordance with another aspect of the present invention, the imaging apparatus may further include a base arranged to support the stabilization lens assembly to be capable of being rotated about a shaft parallel to the optical axis, and the stabilization lens assembly may be rotated about the shaft to retreat the optical image stabilization lens from the optical axis.

In accordance with aspects of the present invention, it is possible to retreat an optical image stabilization lens in a lens barrel from an optical axis as well as to move the optical image stabilization lens in the direction of the optical axis to be accommodated in a desired position.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIGS. 1A and 1B are schematic views illustrating a state in which a lens barrel is being retracted according to an exemplary embodiment of the present invention;

FIGS. 2A and 2B are schematic views illustrating a lens barrel in a retraction-released state (i.e., a state for photographing) according to an exemplary embodiment of the present invention;

FIG. 3 is an exploded perspective view illustrating the construction of an Optical Image Stabilization (OIS) lens group according to an exemplary embodiment of the present invention;

FIG. 4 is a schematic view illustrating a first state in which an OIS lens is positioned on an optical axis according to an exemplary embodiment of the present invention;

FIG. 5 is a schematic view illustrating a second state in which an OIS lens is retracted below an optical axis according to an exemplary embodiment of the present invention;

FIG. 6 is a schematic view illustrating an aspect in which a hole of an OIS lens assembly is fitted on a shaft of an OIS base according to an exemplary embodiment of the present invention;

FIGS. 7A to 7C are schematic views illustrating an OIS lens group shown from an imaging device side according to an exemplary embodiment of the present invention;

FIGS. 8A to 8C are schematic views illustrating the area B surrounded by an alternating long and short dash line in FIGS. 7A to 7C in enlarged scales according to an exemplary embodiment of the present invention;

FIG. 8D is a schematic view of a protrusion and a bulge shown in the direction indicated by the arrow A2 in FIG. 8A according to an exemplary embodiment of the present invention; and

FIG. 9 is a schematic view illustrating a state in which a protrusion extending from a stationary frame abuts a slope of a retractor guide in the process of retracting according to an exemplary embodiment of the present invention.

Throughout the drawings, it should be noted that like reference numbers are used to depict the same or similar elements, features, and structures.

### DETAILED DESCRIPTION OF EMBODIMENTS OF THE PRESENT INVENTION

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

### [Exemplary Construction of Lens Barrel]

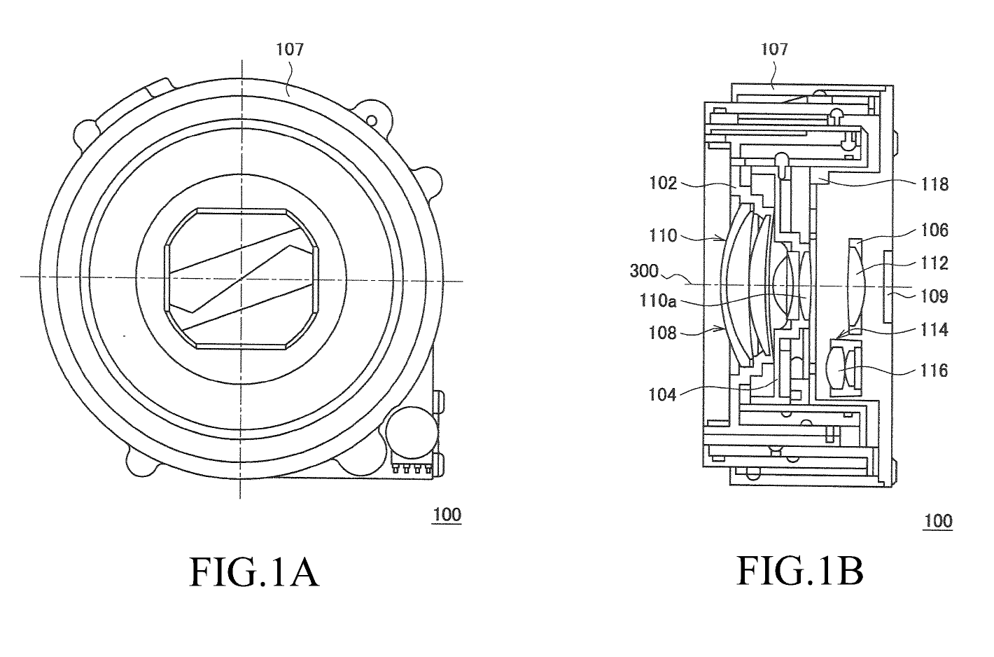

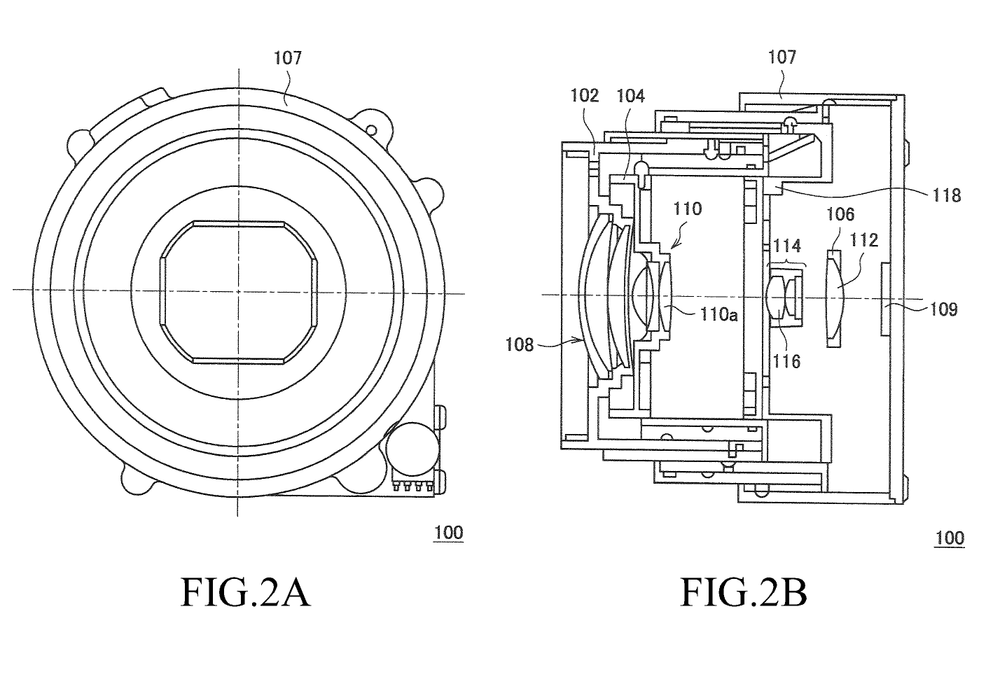

A general construction of a lens barrel 100 of an imaging apparatus according to an exemplary embodiment of the present invention is described with reference to FIGS. 1A, 1B, 2A, and 2B.

FIGS. 1A and 1B are schematic views illustrating a state in which a lens barrel is being retracted according to an exemplary embodiment of the present invention, and FIGS. 2A and 2B are schematic views illustrating a lens barrel in a retraction-released state (i.e., a state for photographing) according to an exemplary embodiment of the present invention. FIGS. 1A and 2A illustrate the lens barrel 100 shown from a subject side, and FIGS. 1B and 2B illustrate the cross-section of the lens barrel 100 taken along the optical axis 300 of the lens barrel 100.

Referring to FIGS. 2A and 2B, the lens barrel 100 includes lens frames 102, 104 and 106 and a stationary frame 107. The lens frame 102 retains a first lens group 108, and the lens frame 104 retains a second lens group 110. In addition, the lens frame 106 retains a third lens group 112. The first lens group 108 and the second lens group 110 move in the direction of the optical axis at the time of zooming, and the third lens group 112 moves in the direction of the optical axis at the time of focusing.

An Optical Image Stabilization (OIS) lens group 114 is arranged between the second lens group 110 and the third lens group 112. The OIS lens group 114 includes an OIS lens 116 that moves in a direction perpendicular to the optical axis according to hand shaking so as to correct the hand shaking.

Referring to FIGS. 1A and 1B, in the state of retraction, the lens frames 102, 104 and 106 are retreated toward an imaging device 109, and the length of the lens barrel 100 in the direction of the optical axis is reduced to a minimum. In addition, as illustrated in FIGS. 2A and 2B, at the time of releasing the retraction (at the time of photographing), the lens frames 102, 104 and 106 are released to the subject side. The first lens group 108, the second lens group 110, and the third lens group 112 are included in an imaging optical system for imaging an optical image of a subject, and the imaging device 109 has an imaging plane on which the optical image of the subject is imaged by the imaging optical system.

At the time of retraction, the lens 110a closest to the imaging device 109 side in the second lens group 110 approaches the OIS lens group 114. If the OIS lens 116 is positioned on the optical axis 300, a distance between the lens 110a and the OIS lens 116 should be secured such that the retraction amount of the second lens group 110 is restricted. The retraction amount of the second lens group 110 is further reduced, and the entire length of the lens barrel 100 at the time of retraction is increased.

For this reason, the lens barrel 100 retreats the OIS lens group 114 downward with respect to the optical axis 300 at the time of retraction as illustrated in FIG. 1B. In addition, at the time of retraction, the OIS lens 116 is retreated backward (toward the imaging device 109) with respect to an OIS lens retaining frame 118 that retains the OIS lens 116 in the state in which the OIS lens 116 is retreated from the optical axis 300. Due to this, it becomes possible to reduce the entire length at the time of retraction.

In a case where the size of the lens barrel 100 is reduced, the number of retraction steps provided should be increased such that the moving amount of each lens group is increased. In such a case, the number of cams needed for the retraction movement is also increased, which may occasionally raise an obstacle to reducing the size of the lens barrel. According to exemplary embodiments of the present invention, in order to further reduce the entire length of the lens barrel 100 at the time of retraction, the OIS lens 116 is also moved forward and backward (in the direction of the optical axis) to be capable of receiving a retracted lens group by using the unused space in the imaging device 109 side more efficiently, which makes it possible to further increase the retraction amount of the second lens group 110 to further reduce the size of the lens barrel 100. For example, if the OIS lens 116 were moved by 2 mm toward the imaging device 109 at the time of retraction, the retraction amount of the second lens group 110 may also be increased at least by 2 mm as compared to the case in which the OIS lens 116 is not moved toward the imaging device 109. Accordingly, the size of the lens barrel 100 and the imaging device may be reduced.

### [Construction of OIS Lens Group]

The construction of the OIS lens group 114 is described below.

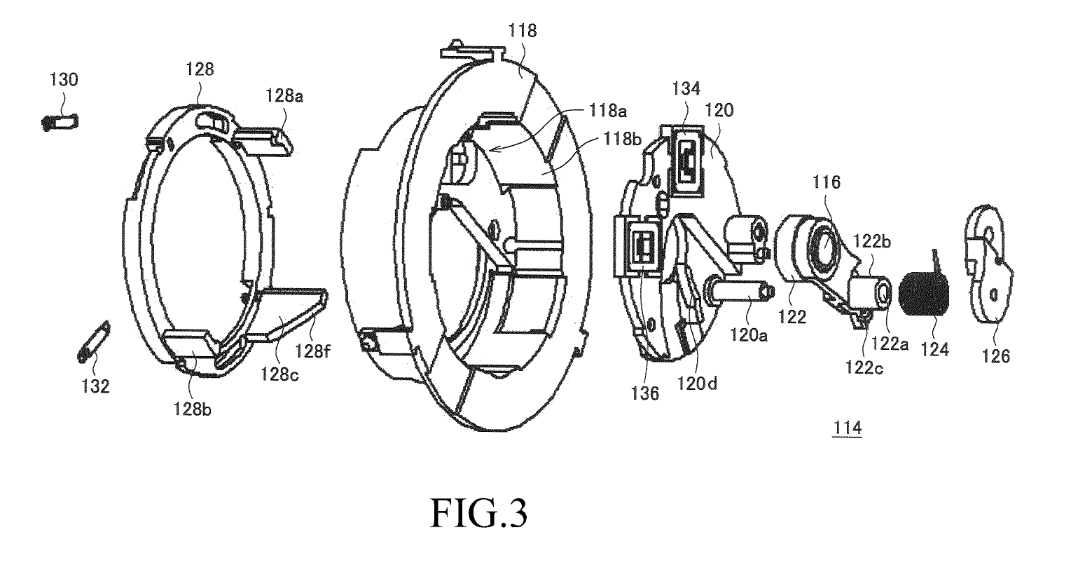

FIG. 3 is an exploded perspective view illustrating a construction of an OIS lens group according to an exemplary embodiment of the present invention.

Referring to FIG. 3, the OIS lens group 114 includes a lens retaining frame 118, an OIS base 120, an OIS lens assembly 122, a spring 124, a holder 126, a retractor guide (fixing member) 128, and springs 130 and 132.

The OIS base 120 is equipped with magnets 134 and 136. The OIS base 120 is configured to be movable with respect to the OIS lens retaining frame 118 in two directions perpendicular to the optical axis 300 by the magnetic force of the magnets 134 and 136. The OIS base 120 is also equipped with the lens assembly 122. The OIS lens 116 is fixed to the OIS lens assembly 122. At the time of releasing the retraction as illustrated in FIGS. 2A and 2B, the OIS lens 116 is arranged on the optical axis 300, and is driven in unison with the OIS base 120. When the movement of the lens barrel 100 caused by hand shaking is detected, the OIS base 120 is driven with respect to the OIS lens retaining frame 118 in a direction perpendicular to the optical axis, which causes the imaging position on the imaging plane of the imaging device 109 to be changed, so that the deterioration of an image due to the hand shaking can be corrected.

The OIS base 120 is provided with a shaft 120a. The OIS lens assembly 122 is formed with a bore 122a into which the shaft 120a is inserted, and the OIS lens assembly 122 is configured to be rotationally moved in the state in which the shaft 120a is inserted into the bore 122a. With this construction, the OIS lens assembly 122 is movable between a first state in which the OIS lens 116 is positioned on the optical axis 300, and a second state in which the OIS lens 116 is retreated to a side lower than the optical axis 300.

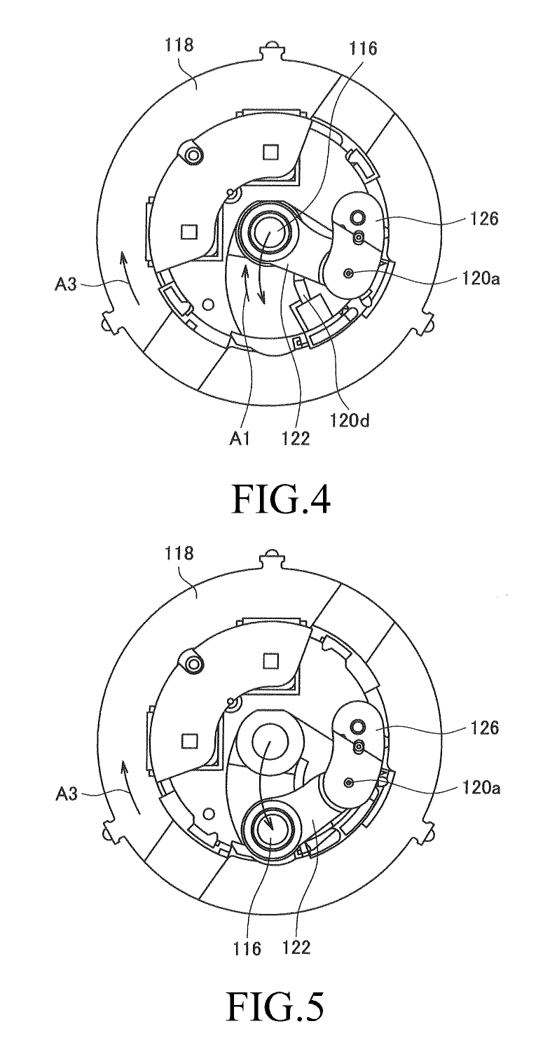

FIGS. 4 and 5 are schematic views of an OIS lens group shown from an imaging device side according to an exemplary embodiment of the present invention. FIG. 4 illustrates a first state in which an OIS lens is positioned on an optical axis 300, and FIG. 5 illustrates a second state in which an OIS lens 116 is retracted below an optical axis.

Referring to FIGS. 4 and 5, by being rotated about the shaft 120a, the OIS lens assembly 122 is set to the positions of the first and second states.

The holder 126 is fixed to the OIS base 120 while the shaft 120a is inserted into the bore 122a, and prevents the OIS lens assembly 122 from escaping from the shaft 120a. The spring 124 may be a coil spring, and is inserted into a boss 122b formed with the bore 122a, in which the spring 124 elastically biases the OIS lens assembly 122 toward the first state (in the direction indicated by arrow A1 in FIGS. 4 and 5).

As illustrated in FIGS. 3 to 5, the OIS base 120 is formed with a slope 120d, and the OIS lens assembly abuts the slope 120d. The slope 120d is configured such that its height is increased from the OIS base 120 to the imaging device 109 side as it is spaced away from the optical axis 300. Due to this, the OIS lens assembly 122 is moved toward the imaging device 109 by the slope 120d as the OIS lens assembly 122 transits from the first state to the second state.

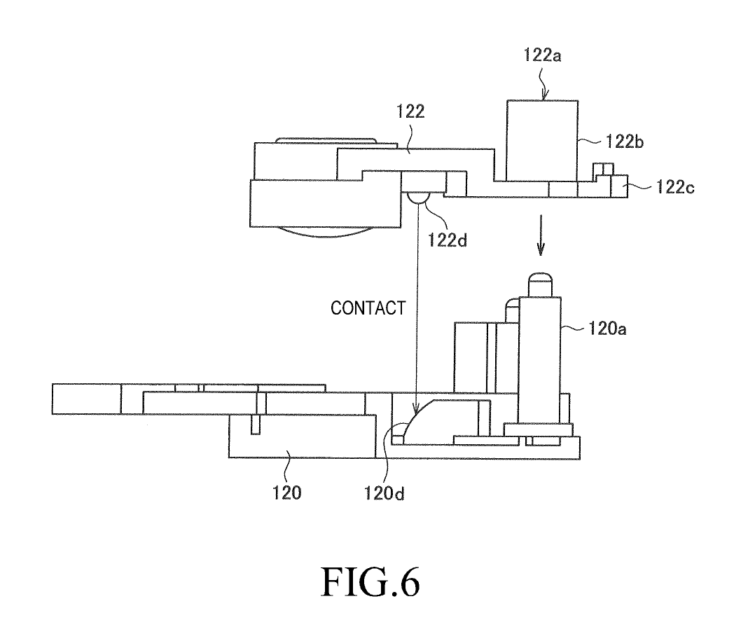

FIG. 6 is a schematic view illustrating an aspect in which a hole of an OSI lens assembly is fitted on a shaft 120a of an OIS base according to an exemplary embodiment of the present invention.

Referring to FIG. 6, when the bore 122a is fitted on the shaft 120a, the protrusion 122d of the OIS lens assembly 122 abuts the slope 120d. The OIS lens assembly 122 is elastically biased toward the OIS base 120 by the spring 124, and the protrusion 122d always abuts the slope 120d. The spring 124 elastically biases the lens assembly 122 to one rotating direction about the shaft 120a, and at the same time, elastically biases the OIS lens assembly 122 to the direction of optical axis. Thus, as the OIS lens assembly 122 transits from the first state to the second state, the protrusion 122d of the OIS lens assembly 122 ascends the slope 120d, so that the lens assembly 122 is moved toward the imaging device 109 side. In addition, since the slope 120d restrains the moving amount of the OIS lens assembly 122 in the direction of the optical axis, the OIS lens assembly 122 is configured to be moved in the direction in parallel with the rotating direction of the OIS lens assembly (only in a direction perpendicular to the optical axis) after being moved by a predetermined moving amount.

The retractor guide 128 is configured such that its outer periphery is rotatably fitted in the inner periphery 118b of the OIS lens retaining frame 118. As illustrated in FIG. 3, the retractor guide 128 is provided with three protrusions 128a, 128b and 128c which are extending toward the imaging device 109 side. The three protrusions 128a, 128b and 128c are configured to be introduced through the holes 118a provided in the OIS retaining frame 118, and to be engaged with the OIS base 120 and the OIS lens assembly 122.

The protrusions 128a and 128b suppress the movement of the OIS base 120 with respect to the OIS lens retaining frame 118. In addition, the protrusion 128c enable rotation of the OIS lens assembly 122 between the first state and the second state.

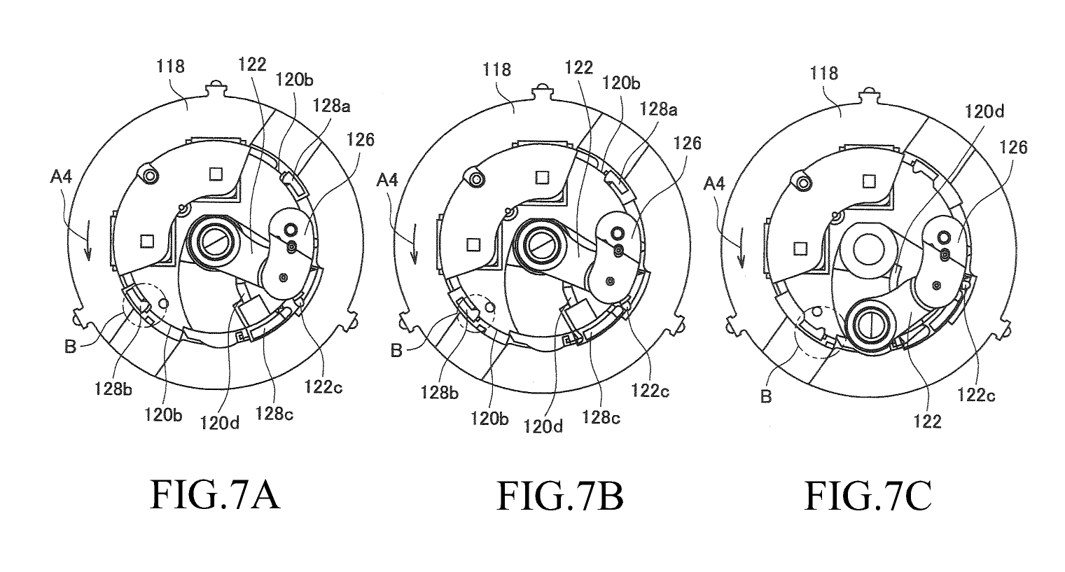

FIGS. 7A to 7C are schematic views illustrating an OIS lens group 110 from an imaging device 109 according to an exemplary embodiment of the present invention, in which due to the rotation of the retractor guide 128, the OIS lens assembly 122 is moved from the first state to the second state, and the OIS base 120 is fixed with respect to the OIS lens retaining frame 118.

Referring to FIGS. 7A-7C, FIG. 7A illustrates the state in which the OIS lens assembly 122 is positioned in the first state. In this state, the OIS lens 116 is positioned on the optical axis by the biasing force of the spring 124. When the retractor guide 128 is rotated counterclockwise from the state illustrated in FIG. 7A, the protrusion 128c of the retractor guide 128 abuts the protrusion 122c provided on the outside of the OIS lens assembly 122. When the retractor guide 128 is further rotated counterclockwise from this state, the protrusion 122c is pushed by the protrusion 128c, so that the OIS lens assembly 122 will be rotated toward the second state. In addition, as illustrated in FIG. 7C, when the retractor guide 128 is rotated to the terminal end of counterclockwise rotation, the OIS lens assembly 122 rotated by being pushed by the protrusion 128c arrives at the position of the second state. The OIS lens assembly 122 moves the optical direction to the imaging device 109 side as the OIS lens assembly 122 transits from the first state to the second state since the protrusion 122d abuts the slope 120d.

When the retractor guide 128 is rotated counterclockwise, the OIS base 120 is fixed with respect to the OIS lens retaining frame 118 by the protrusions 128a and 128b. As illustrated in FIGS. 7A to 7C, the OIS base 120 is provided with a bulge 120b, the outer diameter of which is larger than the parts neighbored thereto. The outer diameter of the bulge 120b coincides with the size of the inner diameter of the protrusions 128a and 128b. When the retractor guide 128 is rotated counterclockwise, the bulges 120b and the protrusions 128a and 128b coincide with each other in angular position, and the outer diameter of the bulge 120b is retained by the inner diameter of the protrusions 128a and 128b.

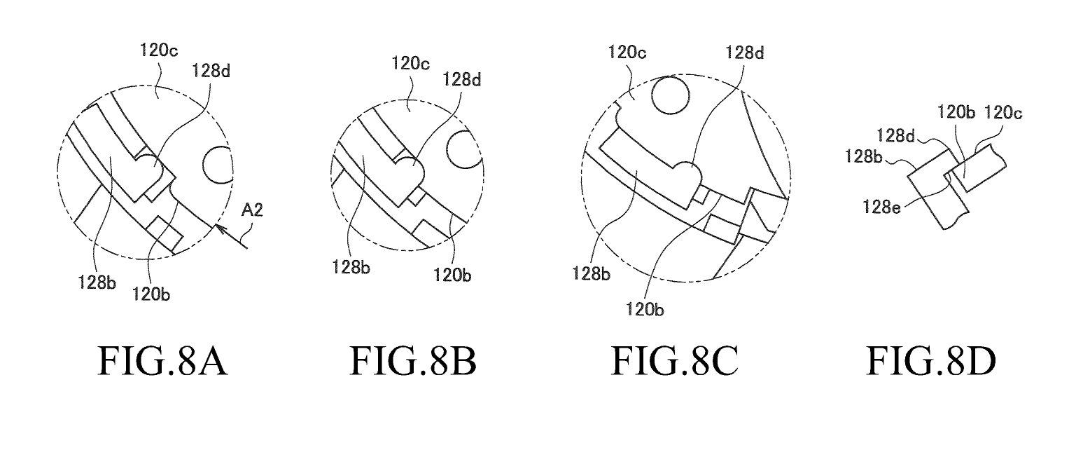

FIGS. 8A to 8C are schematic views illustrating an area B surrounded by an alternating long and short dash line in FIGS. 7A to 7C in enlarged scales according to an exemplary embodiment of the present invention, in which FIGS. 8A to 8C correspond to FIGS. 7A to 7C, respectively. In addition, FIG. 8D is a schematic view of a protrusion and a bulge shown in the direction indicated by arrow A2 in FIG. 8A according to an exemplary embodiment of the present invention.

Referring to FIGS. 8A-8D, at the tip end of the protrusion 128b, a protrusion 128b is provided which protrudes to the optical axis 300 side. Likewise, at the tip end of the protrusion 128a, a protrusion 128d is provided which protrudes toward the optical axis side. The subject side surface 128e of the protrusion 128d is positionally coincident with the imaging device 109 side surface 120c of the bulge 120b.

In the states illustrated in FIGS. 7A and 8A, the outer diameter of the bulge 120b and the inner diameter of the protrusions 128a and 128b do not abut each other. Therefore, the OIS base 120 is capable of being moved in two directions perpendicular to the optical axis. Due to this, the correction of hand shaking is performed by the movement of the OIS base 120 as described above.

As illustrated in FIGS. 7B and 8B, when the retractor guide 128 is rotated counterclockwise (in the direction indicated by arrow A4), the angular positions of the outer diameter of the bulge 120b and the inner diameter of the protrusions 128a and 128b with reference to the optical axis overlap and the outer diameter of the bulge 120b and the inner diameter of the protrusions 128a and 128b begin to abut each other. Due to this, the OIS base 120 is retained by the retractor guide 128 in a direction perpendicular to the optical axis 300. In addition, the subject side surface 128e of the protrusion 128d and the imaging device 109 side surface 120c of the bulge 120b abut each other, and the movement of the OIS base 120 to the imaging device 109 side is restrained.

As illustrated in FIGS. 7C and 8C, when the retractor guide 128 is rotated to the terminal end of the counterclockwise rotation, the outer diameter of the bulge 120b and the inner diameter of the protrusions 128a and 128b completely abut each other. In this situation, the OIS base 120 is retained by the retractor guide 128 in the direction perpendicular to the optical axis 300. If the OIS lens base 120 is retained by the retractor guide 128 in the direction perpendicular to the optical axis since the outer diameter of the retractor guide 128 is rotatably fitted in the inner diameter of the OIS lens retaining frame 118, the OIS base 120 is retained by the OIS lens retaining frame 118 in the direction perpendicular to the optical axis.

In addition, in the state illustrated in FIGS. 7C and 8C, the subject side surface 128e of the protrusion 128d and the imaging device 109 side surface 120c of the bulge 120b abut each other. Due to this, the protrusion 128d and the OIS base 120 are engaged with each other. The subject side of the OIS base 120 always abuts the imaging device 109 side of the OIS lens retaining frame 118. Thus, as the protrusion 128d and the OIS base 120 are engaged with each other, the movement of the OIS base 120 to the imaging device 109 side is restrained. Thus, in the state illustrated in FIGS. 7C and 8C, the OIS base 120 is fixed with respect to the OIS lens retaining frame 118 in either of the direction of the optical axis or the direction perpendicular to the optical axis.

Due to this, in retraction, it is possible to suppress the OIS base 120 from being moved within the lens barrel 100, and in a construction in which the OIS lens 116 is retreated from the optical axis 300 at the time of retraction, it is possible to stably retain the OIS lens 116 in the fixed state.

Since the OIS base 120 should be moved in two directions (up and down, left and right) perpendicular to the optical direction at the time of correcting hand shaking (at the time of OIS), the OIS base 120 is configured such that positioning is performed only by the force of the magnets 134 and 136, and the OIS base 120 is freely movable in the two directions perpendicular to the optical axis in correspondence with the force of the magnets 134 and 136. However, since the OIS lens assembly 122 is pushed by the retractor guide 128 at the time of retreating, the OIS base 120 is moved unless the OIS base 120 is fixed with respect to the OIS lens retaining frame 118 by the retractor guide 128. Consequently, the retreating movement may be hindered. According to exemplary embodiments of the present invention, since the OIS base 120 is fixed with respect to the OIS lens retaining frame 118 when the OIS lens 116 is retreated, it is possible to stably retreat the OIS lens 116.

In the case of transition from retraction to retraction release, actions opposite to the above-mentioned actions are performed. In such a case, when the retractor guide 128 is rotated clockwise from the state illustrated in FIG. 7C, the OIS lens assembly 122 is rotated toward the first state by the biasing force of the spring 124. When the retractor guide 128 is returned to the state illustrated in FIG. 7A, the OIS lens 116 is returned to the position on the optical axis 300. In addition, when the retractor guide 128 is returned to the state illustrated in FIG. 7A, the engagement of the bulge 120b and protrusions 128a and 128b is released, so that the OIS base 120 is allowed to be moved in a direction perpendicular to the optical axis 300 with respect to the OIS lens retaining frame 118.

According to exemplary embodiments of the present invention, the OIS lens assembly 122 can be rotated between the first position and the second position by the rotating action of the retractor guide 128. In addition, by the rotating action of the retractor guide 128, the OIS base 120 can be fixed with respect to the OIS lens retaining frame 118, and the fixation can be released.

In addition, by using the slope 120d for moving the OIS lens assembly 122, not only the retreating action in the rotating direction but also the retreating action in the forward and backward direction (in the direction of the optical axis) can be performed. Due to this, it is possible to further reduce the entire length of the lens barrel at the time of retraction.

The construction for rotating the retractor guide 128 will be described below. As illustrated in FIG. 3, the protrusion 128c of the retractor guide 128 is provided with a slope 128f. The retractor guide 128 is elastically biased to be rotated about the optical axis 300 in the direction indicated by arrow A3 in FIGS. 4 and 5 by the biasing force of the springs 130 and 132.

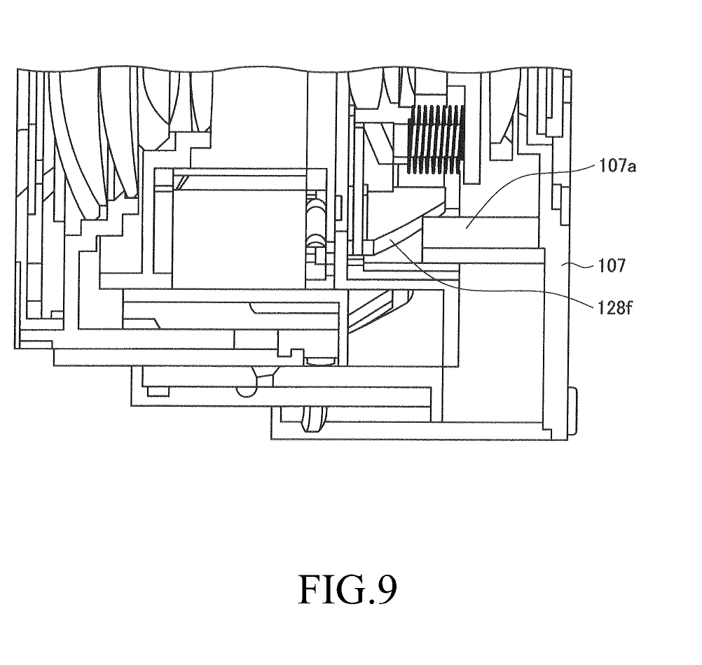

FIG. 9 is a schematic view illustrating a state in which a protrusion extending from a stationary frame abuts a slope of a retractor guide in the process of retracting according to an exemplary embodiment of the present invention.

Referring to FIG. 9, when the OIS lens group 114 is moved to the imaging device 109 side following the retraction, the protrusion 107a extending from the stationary frame 107 abuts the slope 128f of the retractor guide 128, and the OIS lens group 110 is moved to the imaging device 109 side. As a result, the retractor guide 128 is rotated in the direction opposite to arrow A3 illustrated in FIGS. 4 and 5 by a component of the force received by the slope 128f from the protrusion 107a. Due to this, at the time of transition from retraction release to retraction, the retractor guide 128 can be rotated in the direction indicated by arrow A4 in FIGS. 7A to 7C.

Since the retractor guide 128 is elastically biased to be rotated about the optical axis 300 in the direction indicated by arrow A4 in FIGS. 4 and 5 by the biasing force of the spring 130 and 132 at the time of transition from retraction to retraction release, the retractor guide 128 is rotated in the direction indicated by arrow A4 in FIGS. 7A to 7C and returned to the state illustrated in FIG. 7A following the movement of the slope 128f to the subject side. Due to this, the fixation of the OIS base 120 with respect to the OIS lens retaining frame 118 is released simultaneously when the OIS lens assembly 122 is returned to the first position.

According to exemplary embodiments of the present invention, since the OIS lens 116 for correcting hand shaking is configured to be moved in the direction of the optical axis 300 as well as to be retreated from the optical axis 300, it is possible to prevent the retraction action from being disturbed by the OIS lens 116. Thus, it is possible to reduce the entire length of the lens barrel 100 to a minimum at the time of retraction.

In addition, since it is possible to fix the OIS base 120 with respect to the OIS lens retaining frame 118 at the time of retraction, it is possible to reduce the movement of the OIS base 120 with respect to the lens retaining frame 118 even while an electric current to the magnets 134 and 136 is turned off at the time of retraction.

While the invention has been shown and described with reference to certain exemplary embodiments thereof, It will be understood by those skilled in the art that various changes in form and details may be made therein without departing from the spirit and scope of the invention as defined by the appended claims and their equivalents.

What is claimed is:

1. A lens barrel comprising:
a lens group arranged to move in the direction of an optical axis at the time of retraction;
an optical image stabilization lens arranged to be movable in a direction perpendicular to the optical axis; and
a stabilization lens assembly equipped with the optical image stabilization lens, the stabilization lens assembly being arranged to move the optical image stabilization lens in the direction following the optical axis as well as to retreat the optical image stabilization lens from the optical axis at the time of retraction of the lens group.

2. The lens barrel as claimed in claim 1, further comprising:
a base arranged to support the stabilization lens assembly to be capable of being rotated about a shaft parallel to the optical axis,
wherein the stabilization lens assembly is rotated about the shaft to retreat the optical image stabilization lens from the optical axis.

3. The lens barrel as claimed in claim 2, wherein the base is provided with a slope, against which the stabilization lens assembly abuts, and
wherein the stabilization lens assembly is arranged to move along the slope when the stabilization lens is rotated about the shaft to move the optical image stabilization lens in the direction following the optical axis.

4. The lens barrel as claimed in claim 2, further comprising:
a retaining frame arranged to retain the base to be capable of being moved in the direction perpendicular to the optical axis at the time of releasing the retraction; and
a fixing member supported to be rotatable with respect to the retaining frame, and arranged to fix the base with respect to the retaining frame at the time of retraction.

5. The lens barrel as claimed in claim 4, wherein the fixing member rotates the stabilization lens assembly about the shaft by being rotated at the time of retraction.

6. The lens barrel as claimed in claim 4, wherein the fixing member retains the outer periphery of the base by being rotated at the time of retraction, thereby fixing the base with respect to the retaining frame in the direction perpendicular to the optical axis.

7. The lens barrel as claimed in claim 6, wherein the fixing member rotates the stabilization lens assembly about the shaft by being rotated at the time of retraction.

8. The lens barrel as claimed in claim 4, wherein the fixing member retains a face of the base perpendicular to the optical axis by being rotated at the time of retraction, thereby fixing the base with respect to the retaining frame in the direction of the optical axis.

9. The lens barrel as claimed in claim 8, wherein the fixing member rotates the stabilization lens assembly about the shaft by being rotated at the time of retraction.

10. An imaging apparatus comprising:
a lens group belonging to an imaging optical system for imaging an optical image of a subject, and arranged to be moved in the direction of an optical axis at the time of retraction;
an imaging device having an imaging plane, to which the optical image of the subject is imaged by the imaging optical system, for converting the optical image into an electric signal;
a optical image stabilization lens belonging to the imaging optical lens, and arranged to be movable in a direction perpendicular to the optical axis; and
a stabilization lens assembly equipped with the optical image stabilization lens, the stabilization lens assembly being arranged to move the optical image stabilization lens in the direction following the optical axis as well as to retreat the optical image stabilization lens from the optical axis at the time of retraction of the lens group.

11. The imaging apparatus as claimed in claim 10, further comprising:
a base configured to support the stabilization lens assembly to be capable of being rotated about a shaft parallel to the optical axis,
wherein the stabilization lens assembly is rotated about the shaft to retreat the optical image stabilization lens from the optical axis.

12. The imaging apparatus as claimed in claim 11, wherein the base is provided with a slope, against which the stabilization lens assembly abuts, and
wherein the stabilization lens assembly is moved along the slope when the stabilization lens assembly is rotated about the shaft to move the optical image stabilization lens in the direction following the optical axis.

13. The imaging apparatus as claimed in claims 11, further comprising:
a retaining frame configured to retain the base to be capable of moving in the direction perpendicular to the optical axis at the time of releasing the retraction; and
a fixing member supported to be rotatable with respect to the retaining frame, and arranged to fix the base with respect to the retaining frame at the time of retraction.

14. The imaging apparatus as claimed in claim 13, wherein the fixing member rotates the stabilization lens assembly about the shaft by being rotated at the time of retraction.

15. The imaging apparatus as claimed in claim 13, wherein the fixing member retains the outer periphery of the base by being rotated at the time of retraction, thereby fixing the base with respect to the retaining frame in the direction perpendicular to the optical axis.

16. The imaging apparatus as claimed in claim 15, wherein the fixing member rotates the stabilization lens assembly about the shaft by being rotated at the time of retraction.

17. The imaging apparatus as claimed in claim 13, wherein the fixing member retains a face of the base perpendicular to the optical axis by being rotated at the time of retraction, thereby fixing the base with respect to the retaining frame in the direction of the optical axis.

18. The imaging apparatus as claimed in claim 17, wherein the fixing member rotates the stabilization lens assembly about the shaft by being rotated at the time of retraction.
